(19) United States
(12) Patent Application Publication
(10) Pub. No.: US 2003/0079021 A1
(43) Pub. Date: Apr. 24, 2003

(54) Method, system and call server for improving network traffic for accounting messages

(76) Inventor: Xiaobo Fan, Montreal (CA)

Correspondence Address: ERICSSON RESEARCH CANADA, 8400 DECARIE BLVD., MONTREAL, QC, H4P 2N2, CA

(21) Appl. No.: 09/682,840

(22) Filed: Oct. 23, 2001

(51) Int. Cl. G06F 15/16

(52) U.S. Cl. 709/227; 709/223

(57) ABSTRACT

A method, system and call server for reducing accounting traffic between a call server and a AAA server following a billing rate change. Following an expiration of a timer indicating the change, the call server collects accounting data of a first portion of the IP session to be billed at a first billing rate. At the next accounting event, if any accounting data is pending transmission to the AAA server, the call server sends to the AAA server an Accounting Stop message with pending accounting data related to the activity during the first portion of the IP session, and then sends an Accounting Start message with no activity parameter. Depending upon the type of the accounting event, the call server further sends to the AAA server the activity parameters related to the second portion of the IP session using an Accounting Stop message or in a next Accounting Interim message.

### BACKGROUND OF INVENTION

1. Field of the Invention

The present invention relates to improving network traffic, and in particular to a method, a system and a Call Server for Improving the network traffic for accounting messages between the call server and an Authentication, Authorization, and Accounting (AAA) server.

2. Description of the Related Art

Various kinds of telecommunications networks are used nowadays for providing different types of services to terminal subscribers. For example, cellular telecommunications networks provide mobile telephone service for cellular subscribers, Local Area Networks (LAN) offer computer connectivity within a given company for computer users, and Internet Service Providers (ISP) have dial-up, cable or microwave access networks providing Internet access for Internet users. Most of these networks have used, or are beginning to use, the Internet Protocol (IP) for packet data communications. For example, besides LANs, WANs (Wide Area Networks), and MANs (Metropolitan Area Networks) of that have historically used the IP protocol for communications, nowadays even cellular telecommunications networks begin implementing voice and data over IP. 2.5 G (2.5 Generation, e.g. General Packet Radio Service (GPRS)) and 3G (Third Generation, e.g. Wideband Code Division Multiple Access (WCDMA), Code Division Multiple Access 2000 (CDMA2000), and Universal Mobile Telecommunication System (UMTS)) cellular telecommunications networks are based on IP packet data communications not only within the core cellular telecommunications network, but also over the air interface.

Since user connectivity within such IP networks is achieved through the establishment of an IP session between the end-user's terminal and the IP network, network operators need a system for monitoring the IP session for the sake of accounting and for billing the subscriber for the provided services.

In the IP networks environment, the entity typically responsible for gathering accounting information is the Authentication, Authorization, and Accounting (AAA) server. Authentication, Authorization, and Accounting (AAA) is a term for a framework for intelligently controlling access to network resources, enforcing policies, auditing usage, and providing the information necessary to bill for services. These combined processes are considered critical for effective network management and security. Authentication provides a way of identifying a user, typically by having the user enter a valid user name and valid password, or by having the terminal transmitting a certain personalized code, before access is granted. Following authentication, a user must gain authorization for doing certain tasks. Simply put, authorization is the process of enforcing policies: determining what types or qualities of activities, resources, or services a user is permitted. In some instances, authorization occurs within the context of authentication. Following authentication, users may be authorized for different types of access or activity. The final plank in the AAA framework is accounting, which measures the resources a user consumes during access. This can include the amount of system time or the amount of data a user has sent and/or received during an IP session. Accounting is carried out by logging of session statistics and usage information and is used for authorization control, billing, trend analysis, resource utilization, and capacity planning activities. Authentication, authorization, and accounting services are oftentimes provided by a dedicated AAA server, a program that performs these functions. A current standard by which network access servers interface with the AAA server is the Remote Authentication Dial-In User Service (RADIUS), herein included by reference.

The AAA server normally receives accounting information from an access or call server handling the given IP session and records the activity ongoing over the IP session, such as for example the duration of the IP session, the start and the end time of the IP session, the amount of uplink and downlink traffic carried over the IP session, etc.

Reference is now made to FIG. 1 (Prior Art), which depicts a simplified nodal operation and signal flow diagram of a typical prior art method for providing accounting messages to a AAA server within a CDMA 2000 network. For simplification purposes, in FIG. 1 there is only shown a Packet Data Service Node (PDSN) 10 of a CDMA 2000 network 12, the PDSN 10 being in communication with a AAA server 14. It is understood that network 12 may comprise other and different kinds of inter-operable telecommunications nodes, including a plurality of mobile terminals connected to the network 12 via corresponding air interfaces. The network 12 shown in FIG. 1 may, for example, be operated according to the specifications of the CDMA 2000 Wireless IP Network Standard TIA/EIA/IS-835, herein included by reference. According to this typical prior art implementation, when a CDMA 2000 mobile subscriber desires to perform a voice and/or data communication using his/her mobile terminal (not shown), first, an IP session is established, action 100. Following the establishment of the IP session, the subscriber can perform the desired communication. During the communication, the PDSN 10 is responsible for monitoring the activity of the IP session and reports to the AAA server 14 activity parameters related to the ongoing IP session. Upon the establishment of the IP session, in action 102 the PDSN 10 sends an Accounting Start message to the AAA server 14 for reporting the beginning of the IP session for the given subscriber. The Accounting Start message typically comprises i) an IP session identification 104, and ii) one or more activity parameters 106 that may take various forms. For example, the activity parameters of the message 102 can comprise an IP session packet counter set to zero, Count=0, (since no traffic has yet occurred over the new IP session), as shown in FIG. 1, or an IP session duration set to zero (since the IP session has just been established, not shown). Following the transmission of the Accounting Start message 102 and until the IP session is terminated, accounting events pre-programmed in the PDSN 10, such as the accounting event 103, trigger the PDSN 10 to send Accounting Interim messages, such as the Accounting Interim message 108 for the purpose of reporting to the AAA server 14 every activity progress over the IP session. The accounting event and consequently the transmission of Accounting Interim messages are usually programmed to occur at regular time intervals ΔT so that the AAA server 14 is regularly informed of the IP session activity. For that purpose, the Accounting Interim message 108 comprises the same IP session identification 104, and one or more updated activity parameter 110 such as for example the data counter Count=0+X, wherein X is the packet data traffic that was carried over the IP session since the establishment of the IP session, action 102. Upon receipt of message 108, the AAA server 14 is informed of the activity that went on the IP session during the time intervals ΔT. Upon termination of the IP session, action 112, the PDSN 10 transmits an Accounting Stop message 114 to the AAA server 14 for reporting the termination of the IP session. The message 114 comprises the IP session identification 104 and an updated activity parameter 116. In some network configurations alike with the one shown in FIG. 1, the updated parameter 116 is cumulative, i.e. it comprises indication of the overall activity that occurred over the IP session since its establishment in action 102. For example, the activity parameter 116 may comprise a packet data counter Count=0+X+Y, wherein Y is the data activity that occurred over IP session since the transmission of the Account Interim message, in action 108.

In some IP networks, such as for example in cellular telecommunications networks and in ISPs access networks, time-of-day dependent billing schemes are implemented. For example, in a given cellular telecommunications network, communications made between 8:00 AM and 6:00 PM may be billed at a first rate, e.g. 20 cents per minute, while all others communications carried out between 6:00 PM and 8:00 AM are billed at a lower rate of 10 cents per minute. Therefore, all communications that are ongoing in a cellular telecommunications network, for example at 6:00 PM, must be billed using a first billing rate for the portion of the communication that was carried on until 6:00 PM, and using a second billing rate for the remaining portion of the communication that follows 6:00 PM. FIG. 2 (Prior Art) is a nodal operation and signal flow diagram illustrating such a scenario for one given IP communication/session. In FIG. 2, the same PDSN 10 and AAA server 14 are shown as being part of a (partially illustrated) IP cellular telecommunications network 12. With reference being now made to FIG. 2, first, the IP session for a given subscriber is started in action 100, and an Accounting Start message 102 is sent to the AAA server 14 as described with reference to FIG. 1. In action 200, a PDSN TimeOfDay Timer expires, or reaches a pre-selected value, such as for example 6:00 PM, which indicates a change in the billing rate of the cellular telecommunications network. Accordingly, the PDSN 10 transmits an Accounting Stop message 202 to the AAA server 14, so that, from the point of view of the AAA server 14, the billing of the current IP session at the first rate is terminated. The message 202 comprises the session identification 104 and an updated activity parameter 110, such as for example a packet data counter Count=0+X, wherein X is the packet data traffic that was carried over the IP session since the transmission of message 102. Therefore, following the receipt of message 202, the AAA server 14 processes all the information needed for billing the subscriber for the session activity that occurred since the establishment of the IP session and until the TimeOfDay Timer expiration in action 200. Immediately following the transmission of message 202, the PDSN 10 transmits to the AAA server 14 an Accounting Start message 204 so that the AAA server 14 starts billing, at the second billing rate, for the remaining portion of the ongoing IP session. The Accounting Start message 204 comprises the same session identification 104 (so that the AAA server can link the first portion of the session with the second portion of the session) and an activity parameter 206 reset to zero. Following a certain period of time ΔT, an Accounting event 103 occurs in PDSN 10, and triggers the PDSN 10 to sends to the AAA server 14 Accounting Interim message, such as for example the Accounting Interim message 208 comprising the session identification 104 along with an updated activity parameter 210 informing the AAA server 14 of the session activity progress since the last accounting message, which in the present case is message 204. As previously stated, the activity parameter 210 may comprise packet data activity, time or session duration information, or any other type of activity parameters a given network operator may find adequate for subscriber billing. For example, the activity parameter 210 can be a packet data counter Count=0+Z, wherein Z represents the packet data activity that occurred over the IP session since the transmission of the message 204. In action 212, the IP session is terminated, and the PDSN 10 sends to the AAA server 14 an Accounting Stop message 214 for informing the AAA server of the termination of the IP session. The message 214 comprises the session identification 104 along with the updated activity parameter 216, which is indicative of the overall activity that occurred over the IP session following the expiry of the TimeOfDay Timer. For example, the activity parameter 216 can be a Packet data traffic counter Count=0+Z+W, wherein W represents the packet data activity that occurred over the IP session since the transmission of the previous message 208.

The prior art method shown in FIG. 2 comprises a major disadvantage in that, immediately after the TimeOfDay Timer expires, action 200, the prior art PDSN 10 transmits the Accounting Stop message 202 and the Accounting Start message 204 in order to inform the AAA server of the end a the prior billing rate period and of the beginning of the new billing rate period. Thus, when the timer expires in action 200, at least messages 202 and 204 must be transmitted substantially simultaneously for all active IP sessions within the cellular telecommunications network, since the billing rate changes at that given time for all cellular subscribers of the network 12. It can be easily observed that even in the case of a medium-size cellular communications network comprising only several million subscribers, and assuming that merely a small fraction (e.g. 3%-5%) of all subscribers are caring IP communications at that given time (e.g. 6:00 PM), the sequence of messages 204 and 208 must be performed at the same time for tens of thousands of subscribers. The sudden increase in the accounting messaging traffic between the PDSN 10 and the AAA server 14 at this given time creates a load that can exceed the capacity of the communication link between the PDSN and the AAA server. Traffic congestion problems can result in the loss of accounting data by the AAA server, which can lead to a loss of revenue for the network operator.

Although there is no prior art solution as the one proposed hereinafter for solving the above-mentioned deficiencies, the Patent 00/44133 issued to Dynarski et al. (hereinafter called Dynarski) bears some relation with the present invention. Dynarski teaches a network access server providing remote access to an IP network for a remote client by initiating a PPP (Point-to-Point Protocol) connection. According to Dynarskin, when a wireless user goes dormant or when it goes out of the range of a given base station the network does not get rid of the PPP state, but rather moves that PPP state to another session on the interface of the wireless network. This allows the user to seamlessly move within the network without the need to renegotiate Link Control Protocol (LCP) and Network Control protocol (NCP) during each handoff. Dynarski also teaches billing the subscriber for both the dormant and the active part of the IP communications. However, Dynarski does not mention the issue of reducing accounting traffic between a call access server and the AAA server, and fails to teach or suggest reducing the bursty accounting traffic during the punctual change of the billing rate following a TimeOfDay Timer expiration.

Accordingly, it should be readily appreciated that in order to overcome the deficiencies and shortcomings of the existing solutions, it would be advantageous to have a method, system and call access server for reducing the bursty accounting messaging traffic occurring between the call access server and cooperating AAA server following a change in the billing rate. It would be particularly advantageous to have method, system and call access server that naturally spread in time the delivery of the accounting messages sent to the AAA server following such a change in order to reduce the bursty traffic.

The present invention provides such a solution.

### SUMMARY OF INVENTION

In one aspect, the present invention is a method for sending accounting data from a call server to an Authentication, Authorization, and Accounting (AAA) server, the method comprising the steps of:during an IP session, following an occurrence of an accounting event in the call server, determining if the call server comprises accounting data pending transmission to the AAA server, the accounting data comprising at least an activity parameter indicative of an activity during a past first portion of the IP session that is to be charged according to a first billing rate; and if the call server comprises accounting data pending transmission to the AAA server:sending from the call server to the AAA server an Accounting Stop message comprising the accounting data; and sending from the call server to the AAA server an Accounting Start message indicative of a start of a second portion of the IP session that is to be charged according to a second billing rate.

In another aspect, the present invention is a telecommunications system comprising:an Authentication, Authorization, and Accounting (AAA) server performing at least a function of accounting for users of the system;a call server handling an IP session and being connected to the AAA server, wherein following an occurrence of an accounting event in the call server, the call server determines if any accounting data is pending transmission to the AAA server, the accounting data comprising at least an activity parameter indicative of an activity during a past first portion of the IP session that is to be charged according to a first billing rate, and wherein if the call server has accounting data pending transmission to the AAA server, i) the call server sends to the AAA server an Accounting Stop message comprising the accounting data; and ii) the call server sends to the AAA server an Accounting Start message indicative of a start of a second portion of the IP session that is to be charged according to a second billing rate.

In yet another aspect, the present invention provides a call server, comprising:means for supporting a provision of an IP session; a TimeOfDay timer for indicating a change of the billing rate applicable in a telecommunications system managed by the call server, from a first billing rate to a second billing rate; and a memory for storing accounting data comprising at least an activity parameter indicative of an activity during a past first portion of the IP session that is to be charged according to the first billing rate, the accounting data being stored in the memory following an expiration of the TimeOfDay timer,wherein, upon occurrence of an accounting event in the call server, the call server determines if accounting data is pending transmission to an Authentication, Authorization, and Accounting (AAA) server, and if so, the call server sends to the AAA server a first Accounting Stop message comprising the accounting data, and the call server further sends to the AAA server an Accounting Start message indicative of a start of a second portion of the IP session that is to be charged according to the second billing rate.

### BRIEF DESCRIPTION OF DRAWINGS

For a more detailed understanding of the invention, for further objects and advantages thereof, reference can now be made to the following description, taken in conjunction with the accompanying drawings, in which:

FIG. 1 (Prior Art) is a nodal operation ad signal flow diagram of a typical prior art implementation for reporting IP session activity to an Authentication, Authorization, and Accounting (AAA) server;

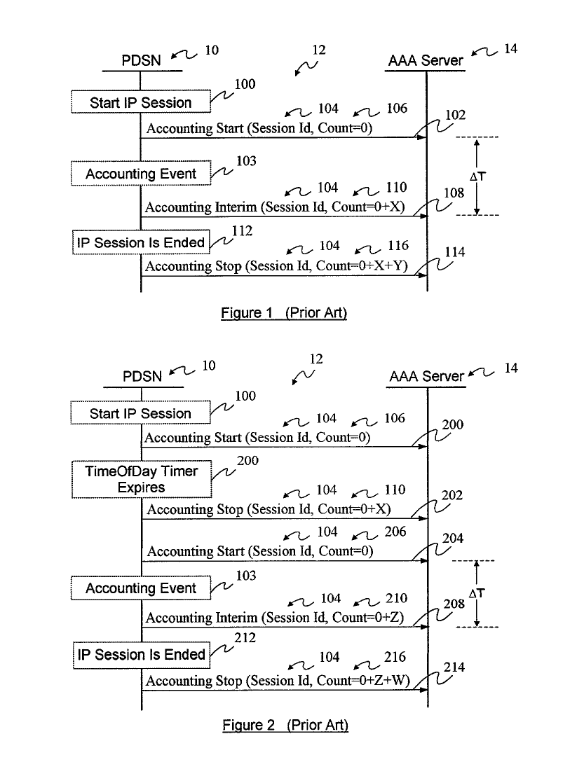

FIG. 2 (Prior Art) is another nodal operation ad signal flow diagram of a typical prior art implementation for reporting IP session activity to an AAA server when a TimeOfDay timer expires and generates a change in the billing rate;

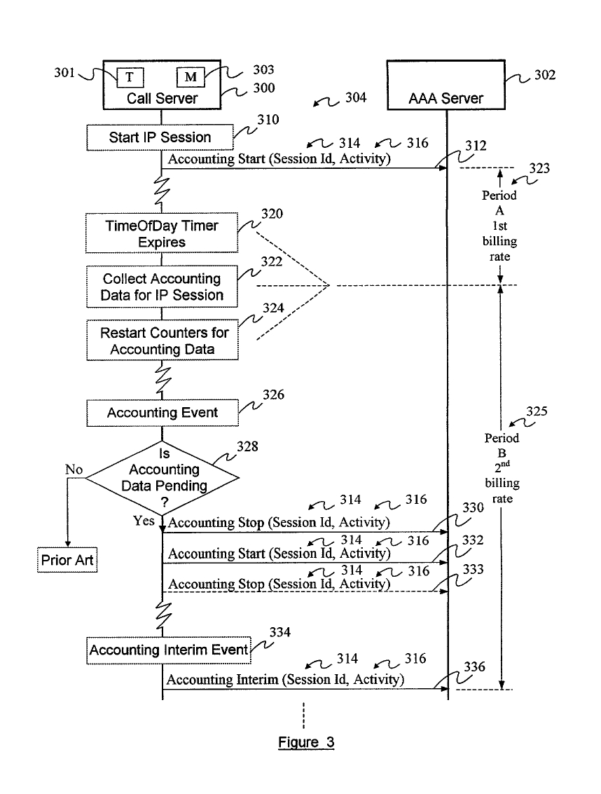

FIG. 3 is a nodal operation and signal flow diagram of an exemplary preferred embodiment of the invention related to a preferred implementation for reporting IP session activity to a AAA server when a TimeOfDay timer expires and generates a change in the billing rate; and

FIG. 4 (Part I and II) is an exemplary illustration of a list of parameters that may be used according to the preferred embodiment of the invention.

### DETAILED DESCRIPTION

The innovative teachings of the present invention will be described with particular reference to one or more exemplary embodiments. However, it should be understood that this class of embodiments provides only an example of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views, and the various elements depicted should not be interpreted as being drawn to scale.

Unlike the prior art scheme for sending account data in a bursty mode from the (Packet Data Service Node) PDSN to the Authentication, Authorization, and Accounting (AAA) server, the present invention transmits the accounting data slowly, spread over a certain period of time. In order to avoid creating a bursty traffic on the link between the PDSN and the AAA server following the expiry of a TimeOfDay Timer (indicative of a change in the billing rate applied to communications handled within the telecommunications network), the present invention makes use of accounting events scheduled and pre-programmed by the network operator in the PDSN, or any other type of call server or access server, and uses accounting messages for relaying any accumulated accounting data related to the previous billing rate to the AAA server. For that purpose, the present invention allows, first, for the storing of the accounting data related to the first portion of the active IP session upon occurrence of a change into the billing rate. Then, when an accounting event occurs, the invention detects if any accounting data related to the previous billing rate is stored in the call server and if so, relays this accounting data to the AAA server. Following the change of the billing rate, the call server initiates a new accounting session for the same active IP session by sending an accounting start message to the AAA server, with activity parameters reset to zero or with no activity parameter at all. Finally, after a pre-selected period of time, accounting messages are sent to the AAA server in order to report the IP session activity status since the change of the billing rate.

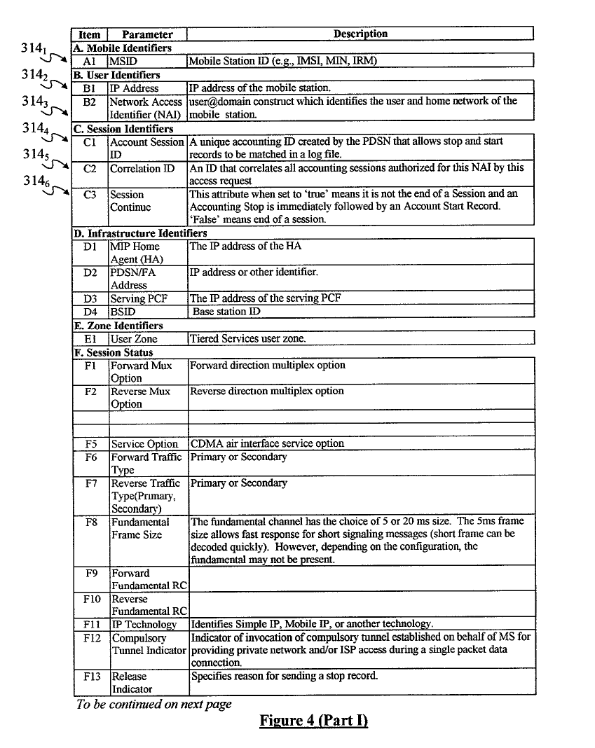

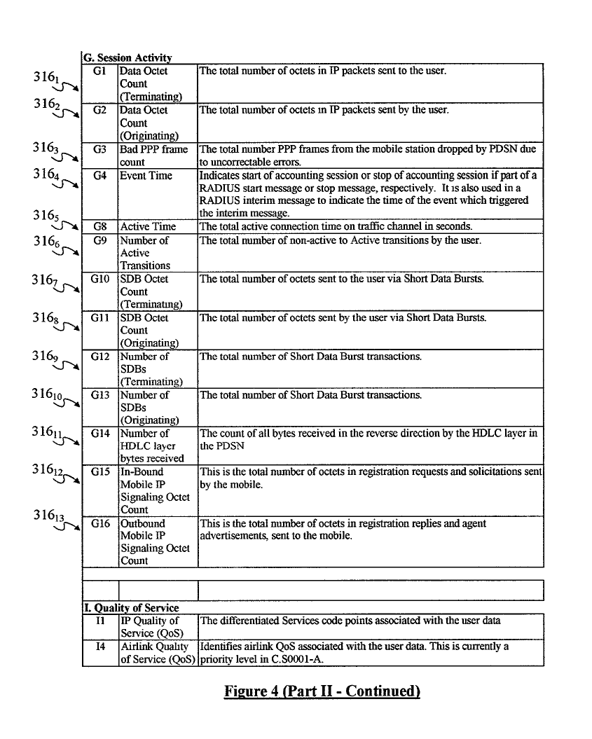

Reference is now made specifically to FIG. 3, which depicts an exemplary nodal operation and signal flow diagram of the preferred embodiment of the present invention in which a Call Server 300 is to report accounting data to a AAA server 302 of a telecommunications network 304. It is to be understood that the term call server utilized herein is used without any limitation and is meant to comprise any kind of telecommunications call server or access server that manages a given communication, such as for example but not limited to, a Call Server Control Function (CSCF), a Mobile Switching Center (MSC), a PDSN, a Serving GPRS Service Node (SGSN), an Internet Service Provider (ISP) Access Server, a Local Area Network (LAN) access server, a Wide Area Network (WAN) access server, or a Metropolitan Area Network (MAN) access server, etc. Likewise, the AAA server 302 can be any kind of server or functionality performing at least the function of accounting on behalf of (at least a part of) the telecommunications network 304. For the sake of the present example, it is assumed that the call server 300 communicates with the AAA server 302 using the RADIUS protocol, as described in the IETF (The Internet Engineering Task Force) RFC (Request for Comments) 2058, 2138, or 2865 about the Remote Authentication Dial In User Service, or the IETF RFC 2059, 2139 and 2866 about the Radius Accounting, all the above-mentioned RFCs being herein included by reference. It is to be noted that for simplification purposes, in FIG. 3, there are only shown the call server 300 and the AAA server 302, although other kinds of telecommunication nodes are understood to be part of the network 304, including a plurality of mobile terminals, whose communications are handled by the call server 300. With reference now being specifically made to FIG. 3, first, an IP session is established in action 310 by the call server 300 for providing support for a voice or data communications to a given subscriber (not shown) of the telecommunications network 304. Upon the establishment of the IP session in action 310, the call server 300 transmits an Accounting Start message, action 312, for informing the AAA server 302 of the establishment of the new IP session, the Accounting Start message comprising first, a session identification parameter 314 for identifying the ongoing IP session, and one or more activity parameters 316 indicative of the activity that was carried on the IP session. Since the Accounting Start message sent in action 312 immediately follows the establishment of the new IP session started in action 310, and that therefore no activity has yet occurred over the IP session, the activity parameter 316 may be set to zero, or may even be inexistent in message 312. Reference is now made to FIG. 4, which shows an exemplary table of RADIUS Accounting parameters from the Wireless IP Network Standard that can be used in accounting-related messages such as in message 312. For example, the session identification parameter 314 may comprise any one or more of the parameters 314₁ to 314₆ as defined in FIG. 4 for allowing the MA server 14 to correctly identify the required items (mobile station, username, etc) in order to allow the telecommunications network to appropriately bill the subscriber for the provided services. In addition, the activity parameter 316 may comprise any one or more of the parameters 316₁ to 316₁₃ for identifying the activity that took place over the IP session.

Reference is now made back to FIG. 3, wherein following the transmission of the Accounting Start message 312, at some later point in time, the TimeOfDay timer 301 expires in the call server 300, action 320. This event is indicative of a change in the billing rate to be applied not only to the entire duration of all IP sessions that will start in the telecommunications network following action 320, but also to the remaining portion of all the active (ongoing) IP sessions. According to the invention, following the expiry of the timer 301, the call server 300 collects accounting data for the ongoing IP session started in action 310 (and as well as for all active (ongoing) IP sessions) and stores the accounting data in a memory 303, action 322. The accounting data collected and stored in action 322 relates to the portion of the IP session that is to be charged to the subscriber using a first billing rate applicable before the expiry of the TimeOfDay timer 301, period A 323. The collected accounting data may typically comprise one or more updated activity parameters 316ᵢ that will be later used to report to the AAA server for the IP session activity. As mentioned, the updated activity parameters 316ᵢ may comprise any one or more of the activity parameters and/or data counters 316₁ to 316₁₃ shown in FIG. 4. Following the collection and storing of the accounting data in action 322, the call server 300 restarts counting the accounting data for the IP session started in 310 (as well as for all active (ongoing) IP sessions) in action 324, with the difference that following action 324 the call server counters (not shown) calculate accounting data referring to the second billing rate that is introduced following the billing rate change in action 320, period B 325.

At a later point in time during the IP session, in action 326, an accounting event occurs, such as for example an accounting interim event or an accounting stop event. An Accounting Interim event is typically an event that is pre-programmed by a network operator or equipment manufacturer to be produced at regular intervals that may trigger a transmission to the AAA server of an interim report related to the current status of the accounting data. The call server generates an Accounting Stop event when the IP session is terminated in order to report to the AAA server activity parameters to indicate the session activity since the beginning of the IP session in action 310.

According to the invention, triggered by the accounting event of action 326, the call server 300 detects in action 328 whether or not there is any accounting data pending (stored in memory 303), for the IP session started in 310 (and likewise for all active (ongoing) IP sessions). If not, the method continues with a typical prior art scheme for handling the report to the AAA server 302. Otherwise, if in action 328 it is detected that for the given IP session accounting data stored in memory 303 is pending, according to the present invention, an Accounting Stop message 330 is sent to the AAA server 302 for informing of the termination of the 1^{st} portion of the IP session that is billed at a first billing rate, and for reporting the pending accounting data related to the first billing rate. For this purpose, the accounting stop message 330 may comprise any one or more session identification parameter 314 as described hereinbefore, and any one or more updated activity parameter 316ᵢ stored in memory 303. Substantially immediately afterwards, the call server 300 sends an Accounting Start message 332 for informing the AAA server 302 of the start of the new billing period B 325, that is to be charged using the second billing rate. The Accounting Start message 332 may comprise a session identification parameter 314 as mentioned along with one or more activity parameter(s) 316. According to a first variant of the preferred embodiment of invention, the activity parameter 316 of the Accounting Start message 332 can be set to zero since the Accounting Start message is indicative of the beginning of a new billing period. Alternatively, according to a second variant of the preferred embodiment of the invention, the activity parameter 316 of the Accounting Start message 332 may comprise an updated activity parameter 316 representative of the IP session activity carried on since the expiration of the TimeOfDay timer in action 320.

If the Accounting Event of action 326 was an Accounting Stop event indicative that the IP session started in action 310 is terminated, the method terminates with the transmission of an Accounting Stop message 333, shown in dotted lines in FIG. 3, which message comprises the session identification parameter 314 as explained, along with an updated activity parameter 316 that is representative of the activity that was carried on over the IP session since the expiration of the TimeOfDay timer 301, in action 320, activity that is to be billed according to the second billing rate, so that the AAA server receives the accounting information related to the second portion of the IP session, too.

Alternatively, if the accounting event of action 326 was an Accounting Interim event, then the IP session continues until at a later point in time when another Accounting Interim event may occur, action 334, which triggers a transmission of an Accounting Interim message 336 for reporting to the AAA server 302 the IP session activity. For this purpose, the accounting interim message 336 comprises the session identification parameter 314 as explained, along with an updated activity parameter 316. According to a first variant of the preferred embodiment of the invention, the activity parameter 316 of the Accounting Interim message 336 is representative of the IP session activity that occurred since the expiration of the TimeOfDay timer in action 320, since the Accounting Start message 322 has not reported any activity to the AAA server 302. Alternatively, according to the a second variant of the preferred embodiment of the invention, the activity parameter 316 of the accounting interim message 336 is representative of the IP session activity that occurred since the transmission of the accounting start message 332, since the later has reported to the AAA server 302 the activity carried on until action 322.

It is to be noted that actions 320, 322 and 324 are performed substantially at the same time so that there is substantially no delay between, first, the expiration of the timer in action 320 and the collection of the accounting data in action 322 and, second, between the collection of the accounting data in action 322 and the restart of the counters for data collection in action 324. Likewise, it is understood and there is substantially no delay between the occurrence of the accounting interim event in action 334 and the transmission of the accounting interim message in action 336.

Furthermore, although similar designations have been used herein for the one or more activity parameters 316 of messages 312, 330, 332, and 336, it is understood that the activity parameters 316ᵢ are preferably of the same nature in each one of the messages 312, 330, 332, and 336, although their individual particular values would most often differ and reflect the instant status of the activity of the IP session since the beginning of the IP session.

Based upon the foregoing, it should now be apparent to those of ordinary skilled in the art that the present invention provides an advantageous solution, which allows the call server 300 to spread over a certain period of time the transmission of the Accounting Stop message 330 and of the Accounting Start message 332 to the AAA server 302, following an expiration of the TimeOfDay timer in action 320. Although FIG. 3 only represents the invented method and system for one single ongoing IP session, many concomitant IP sessions may be handled by the same call server 300 and the same time, and following the expiration of the TimeOfDay timer in action 320, the occurrence in time of the accounting event 326 is typically different for each individual IP session from the many concomitant IP sessions. Therefore, according to the present invention, at a network level, the messages 330 and 332 that are used to report the activity data status from the call server 300 to the AAA server 302 are better spread over time than in the prior art methods, thus greatly reducing the congestion over the link between the call server and the AAA server.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A method for sending accounting data from a call server to an Authentication, Authorization, and Accounting (AAA) server, the method comprising the steps of:
during an IP session, following an occurrence of an accounting event in the call server, determining if the call server comprises accounting data pending transmission to the AAA server, the accounting data comprising at least an activity parameter indicative of an activity during a past first portion of the IP session that is to be charged according to a first billing rate; and
if the call server comprises accounting data pending transmission to the AAA server:
sending from the call server to the AAA server an Accounting Stop message comprising the accounting data; and
sending from the call server to the AAA server an Accounting Start message indicative of a start of a second portion of the IP session that is to be charged according to a second billing rate.

2. The method claimed in claim 1, further comprising prior to the step of determining, the step of:
following a change of a billing rate applicable to the IP session, from the first billing rate to the second billing rate, collecting the accounting data from the call server.

3. The method claimed in claim 2, further comprising the step of:
storing the accounting data in a memory of the call server.

4. The method claimed in claim 2, wherein the change of the billing rate is triggered by an expiration of a TimeOfDay Timer of the call server.

5. The method claimed in claim 1, wherein the accounting event is an accounting stop event indicative of a termination of the IP session, and wherein the method further comprises the step of:
sending from the call server to the AAA server a second Accounting Stop message indicative of a termination of the second portion of the IP session that is to be charged according to the second billing rate, the second Accounting Stop comprising at least an activity parameter indicative of an activity during the second portion of the IP session that is to be charged according to a second billing rate.

6. The method claimed in claim 1, wherein the accounting event is a first accounting interim event.

7. The method claimed in claim 6, wherein the method further comprises the step of:
following an occurrence of a next account interim event in the call server during the IP session, sending from the call server to the AAA server a second Account Interim message comprising at least an activity parameter indicative of an activity during the second portion of the IP session that is to be charged according to the second billing rate.

8. A telecommunications system comprising:
an Authentication, Authorization, and Accounting (AAA) server performing at least a function of accounting for users of the system;
a call server handling an IP session and being connected to the AAA server, wherein following an occurrence of an accounting event in the call server, the call server determines if any accounting data is pending transmission to the AAA server, the accounting data comprising at least an activity parameter indicative of an activity during a past first portion of the IP session that is to be charged according to a first billing rate, and wherein if the call server has accounting data pending transmission to the AAA server, i) the call server sends to the AAA server an Accounting Stop message comprising the accounting data; and ii) the call server sends to the AAA server an Accounting Start message indicative of a start of a second portion of the IP session that is to be charged according to a second billing rate.

9. The telecommunications system claimed in claim 8, wherein before determining if any accounting data is pending transmission to the AAA server, the call server collects the accounting data following a change of a billing rate applicable to the IP session, from the first billing rate to the second billing rate.

10. The telecommunications system claimed in claim 9, wherein the call server stores the accounting data in a memory.

11. The telecommunications system claimed in claim 9, wherein the call server comprises a TimeOfDay timer which expiration triggers the change of the billing rate, from the first billing rate to the second billing rate.

12. The telecommunications system claimed in claim 8, wherein the accounting event is an accounting stop event indicative of a termination of the IP session, and wherein the call server sends to the AAA server a second Accounting Stop message indicative of a stop of the second portion of the IP session that is to be charged according to the second billing rate, the second Accounting Stop message comprising at least an activity parameter indicative of an activity during the second portion of the IP session that is to be charged according to the second billing rate.

13. The telecommunications system claimed in claim 8, wherein the accounting event is a first accounting interim event.

14. The telecommunications system claimed in claim 13, wherein following an occurrence of a next account interim event in the call server during the IP session, the call server sends from the call server to the AAA server a second Account Interim message comprising at least an activity parameter indicative of an activity during the second portion of the IP session that is to be charged according to the second billing rate.

15. A call server, comprising:
means for supporting a provision of an IP session;
a TimeOfDay timer for indicating a change of the billing rate applicable in a telecommunications system managed by the call server, from a first billing rate to a second billing rate; and
a memory for storing accounting data comprising at least an activity parameter indicative of an activity during a past first portion of the IP session that is to be charged according to the first billing rate, the accounting data being stored in the memory following an expiration of the TimeOfDay timer,
wherein, upon occurrence of an accounting event in the call server, the call server determines if accounting data is pending transmission to an Authentication, Authorization, and Accounting (AAA) server, and if so, the call server sends to the AAA server a first Accounting Stop message comprising the accounting data, and the call server further sends to the AAA server an Accounting Start message indicative of a start of a second portion of the IP session that is to be charged according to the second billing rate.

16. The call server claimed in claim 15, wherein before determining if any accounting data is pending transmission to the AAA server, the call server stores the accounting data in the memory following a change of a billing rate applicable to the IP session, from the first billing rate to the second billing rate.

17. The call server claimed in claim 15, wherein the accounting event is an accounting stop event indicative of a termination of the IP session, and wherein following the transmission of the Accounting Start message, the call server further sends to the AAA server a second Accounting Stop message indicative of the termination of the second portion of the IP session that is to be charged according to the second billing rate, the second Accounting Stop comprising at least an activity parameter indicative of an activity during the second portion of the IP session.

18. The call server claimed in claim 15, wherein the accounting event is a first accounting interim event.

19. The call server claimed in claim 18, wherein following an occurrence of a next account interim event in the call server during the IP session, the call server sends from the call server to the AAA server a second account interim message comprising at least an activity parameter indicative of an activity during the second portion of the IP session that is to be charged according to the second billing rate.
